(19) United States
(12) Patent Application Publication
(10) Pub. No.: US 2022/0300036 A1
(43) Pub. Date: Sep. 22, 2022

(54) MULTIFUNCTIONAL NOTEBOOK COMPUTER DOCK

(71) Applicant: Shao-Chieh TING, New Taipei City (TW)

(72) Inventor: Shao-Chieh TING, New Taipei City (TW)

(21) Appl. No.: 17/397,139

(22) Filed: Aug. 9, 2021

(30) Foreign Application Priority Data
Mar. 19, 2021 (TW) 110202966

(51) Int. Cl. G06F 1/16

(52) U.S. Cl. CPC G06F 1/1632; G06F 1/1616

(57) ABSTRACT

A multifunctional notebook computer dock includes a variety of connecting port. The dock solves the insufficiency in the notebook computer, and the notebook computer screen can be elevated. In a meantime, the heat dissipation space at the bottom of the notebook computer can be increased. Two sides and a top surface of the casing are provided respectively with flexible side covers and flexible anti-slip strips. Therefore, the notebook computer is prevented from sliding off. For the multifunctional notebook computer dock, a back side thereof is provided with a space for collecting an external wire, and plugs of the external wire can be inserted into slots on two sides of the dock. Therefore, when a user is out of an office or home, the external wire can be collected and will not be lost.

### BACKGROUND OF THE INVENTION

### a) Field of the Invention

The present invention relates to a multi-port expander installed externally on a notebook computer, and more particularly to a multifunctional notebook computer dock, which solves the difficulty in that there are few connecting ports on a compact notebook computer, with that the dock is able to connect with more equipment, thereby satisfying the user's requirement for expanding interfaces.

### b) Description of the Prior Art

To meet the need for business, the notebook computer product is getting more compact, so as to facilitate carrying when the user is out of an office or home. Therefore, it is inevitably that some heavy-type connecting ports will be decreased for the notebook computer to meet the requirement for compactness.

To solve the above issue of few connecting ports, an external expander arises correspondingly, and there are a variety of expander being sold on the market now.

However, there are still some shortcomings in the existing notebook computer expanders; the product is compact and lightweight, but the interfaces are limited, and the notebook computer cannot be elevated. On the other hand, the interfaces are plenty, but the size is large or the notebook computer is elevated to some limit; in addition, the connecting wire is not collected easily.

Accordingly, a multifunctional notebook computer dock is disclosed. The dock is provided with many interfaces, the notebook computer can be elevated to facilitate dissipating heat from the notebook computer, the height of the notebook computer can be adjusted properly as per the user's need, and the transmission wire can be collected easily.

### SUMMARY OF THE INVENTION

A primary object of the present invention is to provide a multifunctional notebook computer dock. Through a casing made of an extrusion material, side covers made of a flexible material on two sides of the casing, and anti-slip strips made of a flexible material on a top surface of the casing, the notebook computer can be elevated and can be prevented from sliding off, thereby facilitating the user to operate the notebook computer.

A second object of the present invention is to provide a multifunctional notebook computer dock, wherein the ports on the back side thereof are provided with a space for collecting the transmission line, and connection heads of an external wire can be inserted into slots on two sides, so that the external wire can be collected when the user is out of an office or home, thereby preventing the loss of external wire.

A third object of the present invention is to provide a multifunctional notebook computer dock, wherein through a semicircular bottom structure, a consumer can decide the location of the dock below the notebook computer and also select the height that the notebook computer is elevated at a same time.

A fourth object of the present invention is to provide a multifunctional notebook computer dock, wherein an internal PCB (Printed Circuit Board) can be added with a solid-state electronic storage unit to achieve the function of an external hard drive, thereby satisfying a further need of the consumer.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional schematic view of the present invention.

FIG. 2 shows a three-dimensional schematic view of the present invention when an external wire is removed.

FIG. 3 shows a three-dimensional exploded view of the present invention.

FIG. 4 shows a three-dimensional exploded view of the present invention, at another viewing angle.

FIG. 5 shows a three-dimensional exploded view that a PCB of the present invention is added with a solid-state electronic storage unit.

FIG. 6 shows a three-dimensional schematic view that a notebook computer is emplaced on a dock for use, according to the present invention.

FIG. 7 shows another three-dimensional schematic view that a notebook computer is emplaced on the dock for use, according to the present invention.

FIG. 8 shows a side schematic view that a notebook computer is emplaced on the dock for use, according to the present invention.

FIG. 9 shows a three-dimensional schematic view that a tablet personal computer is emplaced on the dock for use, according to the present invention.

FIG. 10 shows another side schematic view that a notebook computer is emplaced on the dock for use, according to the present invention.

### DETAILED DESCRIPTION OF THE PREFERRED EMBODIMENTS

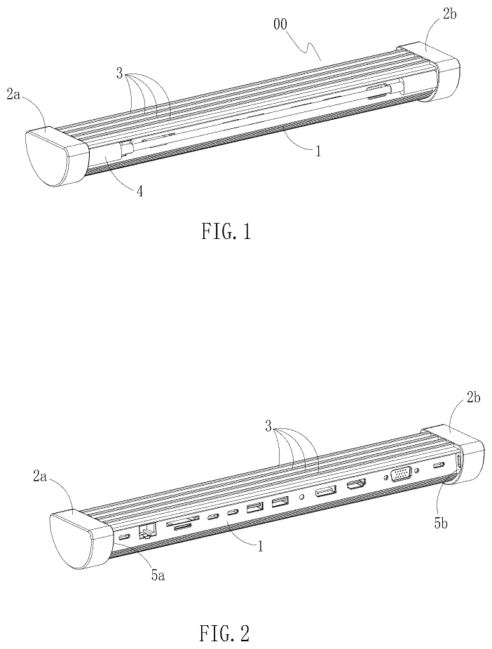

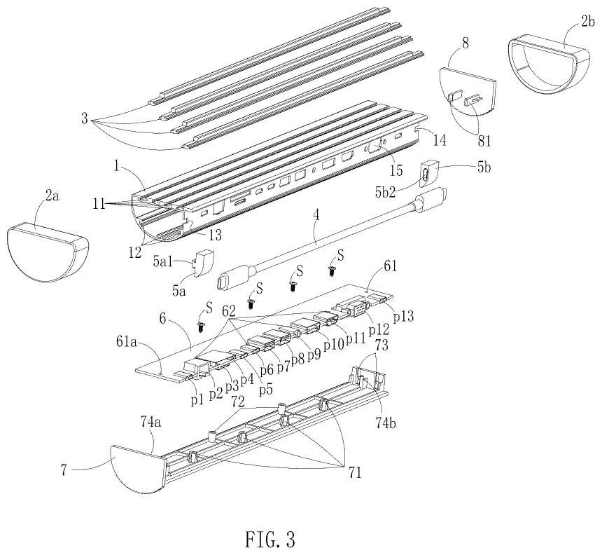

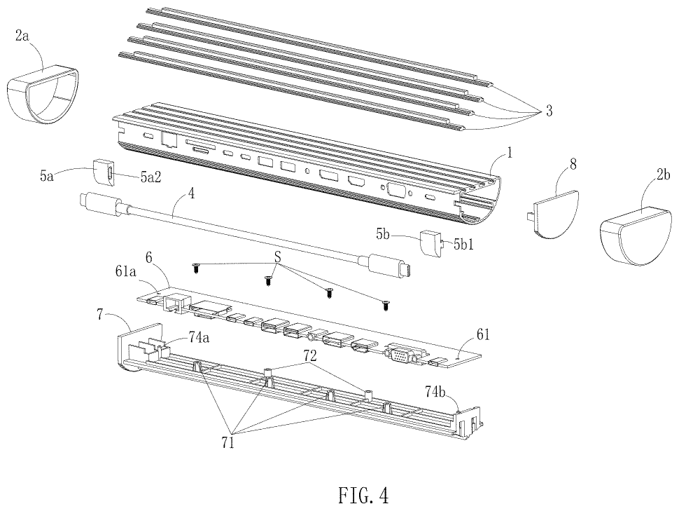

Referring to FIG. 1, FIG. 2, FIG. 3, and FIG. 4, it shows a three-dimensional schematic view of a multifunctional notebook computer dock 00, a three-dimensional schematic view of the multifunctional notebook computer dock 00 when an external wire is removed, a three-dimensional exploded view of the multifunctional notebook computer dock 00, and a three-dimensional exploded view of the multifunctional notebook computer dock 00 at another viewing angle. The multifunctional notebook computer dock 00 comprises primarily a casing 1 made of an extrusion material, side covers 2a, 2b made of a flexible material, plural anti-slip strips 3 made of a flexible material, an external wire 4, external wire sockets 5a, 5b of the external wire 4, a PCB 6, plural connecting ports (USB (Universal Serial Bus)-C power-in port P1, RJ45 port P2, microSD (Secure Digital) port P3, SD port P4, USB 3.1 port P5, USB 4 port P6, USB 3.0 ports P7/P8, audio port P9, display port P10, HDMI (High Definition Multimedia Interface) port 11, VGA (Video Graphics Array) port P12, and USB-C external wire port P13), a PCB mounting bracket 7, a PCB mounting bracket side plate 8, and plural fixing screws S.

The said casing 1 made of the extrusion material is in a shape of a semicircle, and is provided with plural magazines 11 which provide for engaging with the anti-slip strips 3 made of the flexible material. The casing 1 is also provided with plural guide slots 12, and the said guide slots 12 provide for stably positioning a component composed of the PCB 6 and the PCB mounting bracket 7. The casing 1 is provided additionally with plural recesses 13, 14, and the said recesses 13, 14 provide for engaging with the external wire sockets 5a, 5b. On the other hand, the casing 1 is provided with plural port holes 15.

The side covers 2a, 2b made of the flexible material are covered on two sides of the multifunctional notebook computer dock 00, achieving the anti-slip effect when the notebook computer is elevated.

The anti-slip strips 3 made of the flexible material are configured on a top surface of the casing 1 to match the flexible side covers 2a, 2b on two sides, achieving a better anti-slip effect when the notebook computer is elevated.

The said external wire 4 is used to connect the notebook computer with the multifunctional notebook computer dock 00, achieving the application of each expansion port.

The said external wire sockets 5a, 5b are provided respectively with a T-shaped hook 5a1, 5b1, which is used to engage and position with the recesses 13, 14 provided on the extrusion casing 1. The external wire sockets 5a, 5b are also provided respectively with a slot 5a2, 5b2, providing for insertion of a plug on the external wire 4 to facilitate collecting the external wire 4.

The said PCB 6 is provided with plural locating holes 61a/61 and plural tapped holes 62. In addition, the PCB 6 is also provided with plural connecting ports P1˜P13 to satisfy the use of the related connecting ports.

The said PCB mounting bracket 7 is used to fix the PCB 6, and is provided with plural studs 71, allowing the fixing screws S to lock the PCB 6 with the PCB mounting bracket 7 into a single unit. The PCB mounting bracket 7 is also provided with support pillars 72 to support the PCB 6, latch holes 73 to latch and fix with hooks 81 which are disposed on the PCB mounting bracket side plate 8, and locating pillars 74a, 74b to sheath with the locating holes 61a, 61 on the PCB 6, thereby realizing the positioning of PCB 6.

The said PCB mounting bracket side plate 8 is provided with the hooks 81 to engage with the latch holes 73 on the PCB mounting bracket 7, thereby fixing the PCB 6 into the extrusion casing 1.

The fixing screws S are used to lock the PCB 6 and the PCB mounting bracket 7, integrating the two into a single unit to facilitate post-assembling.

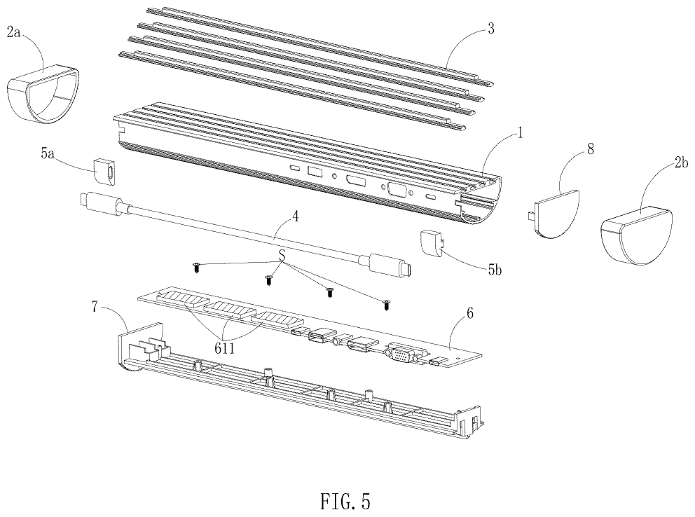

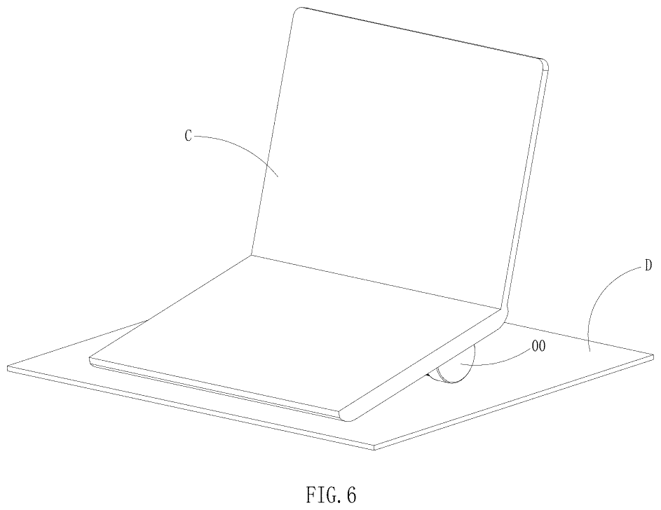

Referring to FIG. 5, part of ports is removed from the PCB 6, and a solid-state electronic storage unit 611 is added, which achieves the function of an external hard drive, thereby satisfying a further need of the consumer.

Referring to FIG. 6, an arc-shaped plane of the multifunctional notebook computer dock 00 is emplaced on a desktop D, and a notebook computer C is elevated, which facilitates dissipating heat from the notebook computer C and even facilitates the user to operate the notebook computer C.

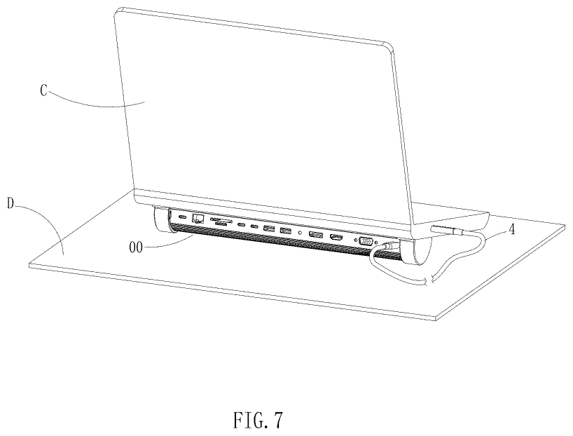

Referring to FIG. 7, it shows a three-dimensional schematic view of a back side of the multifunctional notebook computer dock 00 in use. The drawing shows that the notebook computer C is connected with the multifunctional notebook computer dock 00 through the external wire 4, which achieves the function of related ports on the multifunctional notebook computer dock 00.

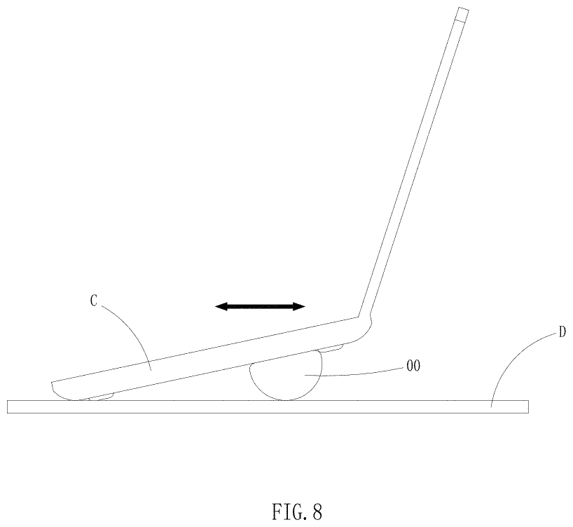

Referring to FIG. 8, it shows a side schematic view when the notebook computer C is emplaced on the multifunctional notebook computer dock 00 for use. When the notebook computer C is moved left or right, the height of the notebook computer C can be adjusted properly according to the user's need.

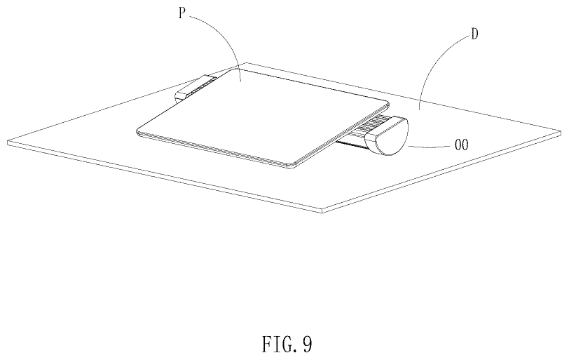

Referring to FIG. 9, it shows a three-dimensional schematic view that a tablet personal computer P is emplaced on the multifunctional notebook computer dock 00 for use.

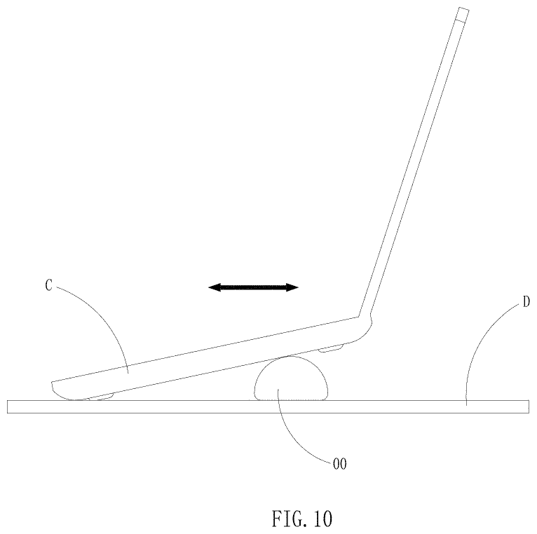

Referring to FIG. 10, the user can put the multifunctional notebook computer dock 00 on the desktop D flat for use, according to the personal convenience in use.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A multifunctional notebook computer dock, comprising:
a casing made of extrusion material;
two side covers made of a flexible material, with the side covers being emplaced on two sides of the extrusion casing;
plural anti-slip strips made of a flexible material, with the anti-slip strips being emplaced on a top surface of the casing;
an external wire which is used connect the notebook computer with the multifunctional notebook computer dock;
two external wire sockets, which are emplaced on two sides of the extrusion casing and are covered by the flexible side covers;
a PCB (Printed Circuit Board) which is provided with plural connecting ports;
a PCB mounting bracket, which is used to fix the PCB; and
a PCB mounting bracket side plate, which is engaged with the PCB mounting bracket to fix the PCB into the extrusion casing.

2. The multifunctional notebook computer dock, according to claim 1,
wherein the extrusion casing is provided with a space for collecting the external wire.

3. The multifunctional notebook computer dock, according to claim 1,
wherein two sides of the multifunctional notebook computer dock are provided respectively with a flexible side cover.

4. The multifunctional notebook computer dock, according to claim 1,
wherein a top surface of the multifunctional notebook computer dock is provided with plural flexible anti-slip strips.
